(19) United States
(12) Patent Application Publication
(10) Pub. No.: US 2009/0230258 A1
(43) Pub. Date: Sep. 17, 2009

(54) Portable tree or pole/post mounted recreational trash bag holder with lid

(76) Inventor: Jeff Noel McFadden, Elk Grove, CA (US)

Correspondence Address: Jeff McFadden, 9330 Corwin Ct., Elk Grove, CA, 95758, US

(21) Appl. No.: 12/075,262

(22) Filed: Mar. 11, 2008

(51) Int. Cl. B65B 67/12; B65F 1/14; B65F 1/16; B65F 1/00

(52) U.S. Cl. 248/101; 248/219.4

(57) ABSTRACT

A device to hold open a trash bag for easy deposit of garbage in a camping or outdoor picnicking environment while securing the invention to a tree or pole/post while also providing a closable lid to cover the opening and keep out insects. A geometrically shaped frame/bracket is secured to a backing frame in which the entire invention may be mounted to a tree by a strap or mounted by brackets onto a pole or post. The trash bag holder frame is encircled by two tension closed arms which hold the bag firmly in place so it does not slip out when loaded with trash. A lid connected by a pivoting swing connector device is positioned in a manner so it may be lifted up to open position to deposit trash and closed to seal off bag opening from intruding insects and minimize odors from wild animals.

### RELATED APPLICATIONS

The present application is related to U.S. Pat. No. 6,648,386, issued Nov. 18, 2003, for REFUSE BAG HOLDER, by Rheinhardt, included by reference herein.

The present application is related to U.S. Pat. No. 7,284,732, issued Oct. 23, 2007, for NON LIFT BAG HOLDER FRAME, by Lopa, included by reference herein.

The present application is related to U.S. Pat. No. 6,604,717, issued Aug. 12, 2003, for BAG HOLDER, by Stanfield, included by reference herein.

The present application is related to U.S. Pat. No. 6,488,241, issued Dec. 3, 2002, for CABINET MOUNTED TRASH BAG HOLDER, by Kyte, et al., included by reference herein.

The present application is related to U.S. Pat. No. D458,131, issued Jun. 4, 2002, for CLOSED RING TRASH BAG HOLDER, by Weber, included by reference herein.

The present application is related to U.S. Pat. No. 6,199,802, issued Mar. 13, 2001, for COLLAPSIBLE TRASH BAG HOLDER, by Scheibe, Sr., included by reference herein.

The present application is related to U.S. Pat. No. 6,086,022, issued Jul. 11, 2000, for SHOULDER-MOUNTED TRASH BAG HOLDER, by Dalton, included by reference herein.

The present application is related to U.S. Pat. No. 6,003,820, issued Dec. 21, 1999, for PLASTIC BAG HOLDER, by Baldonado, et al., included by reference herein.

The present application is related to U.S. Pat. No. 5,842,595, issued Dec. 1, 1998, for MOBILE TRASH/GARBAGE BAG HOLDER WITH OPEN BOTTOM, by Williams, included by reference herein.

The present application is related to U.S. Pat. No. 5,826,838, issued Oct. 27, 1998, for TRASH BAG STAND, by Forbes, included by reference herein.

The present application is related to U.S. Pat. No. 5,735,495, issued Apr. 7, 1998, for TRASH BAG HOLDING DEVICE, by Kubota, included by reference herein.

The present application is related to U.S. Pat. No. 5,735,494, issued Apr. 7, 1998, for BAG HOLDER, by Kurk, included by reference herein.

The present application is related to U.S. Pat. No. 5,718,400, issued Feb. 17, 1998, for TRASH BAG HOLDER WITH HANDLE, by Dwy, included by reference herein.

The present application is related to U.S. Pat. No. 5,456,431, issued Oct. 10, 1995, for APPARATUS FOR SUPPORTING A TRASH BAG, by Ilnisky, included by reference herein.

The present application is related to U.S. Pat. No. 5,139,219, issued Aug. 18, 1992, for BAG HOLDER, by Navarro, included by reference herein.

The present application is related to U.S. Pat. No. 5,020,751, issued Jun. 4, 1991, for GARBAGE BAG AND UTILITY HOLDER, by Larkin, included by reference herein.

### FIELD OF THE INVENTION

The present invention relates to outdoor recreation and, more particularly, to camping

### BACKGROUND OF THE INVENTION

When going camping outdoors, there is often quite a distance from a campsite to the nearest garbage can. Because of this distance, campers will generally store up their trash in a plastic trash bag and once or twice a day take it to a more suitable disposal unit when they walk out before the day's activities. This situation maintains a closed trash bag that is inconvenient to open and close constantly every time it is needed for use to make a deposit to. My trash bag holder not only holds the bag open for convenience in depositing trash and provides an easy way to mount it on a nearby tree trunk, but also has a closable lid which keeps out pests such as yellow-jackets, wasps, and other irritating insects.

There are a number of various other trash bag holders available.

Prior art trash bag holders may hold the bag open constantly for convenience, but in a wildlife, camping environment, the refuse remains exposed to the air which attracts irritating, flying insects such as yellow-jackets, wasps, and bees. Since prior art applications do not contain a lid, the exposure of the trash becomes a strong attractant to flying, stinging insects and other wildlife.

It would be advantageous to provide a method to hold open a trash bag for easy deposits of trash items when camping

It would also be advantageous to provide a method to secure a trash bag holder to a tree since trees are abundant in a camping setting.

It would further be advantageous to provide a method to cover the exposed trash with a lid to keep from attracting stinging and biting insects and other wildlife.

### SUMMARY OF THE INVENTION

In accordance with the present invention, there is provided a device to hold open a trash bag for easy deposit of garbage in a camping or outdoor picnicking environment while securing said device to a tree or pole/post while also providing a closable lid to cover the opening and keep out insects. A geometrically shaped frame or bracket is secured to a backing frame in which said frame may be mounted to a tree by a strap or mounted by brackets onto a pole or post. The trash bag support frame/bracket is encircled by two tension closed arms which hold the trash bag firmly in place so it does not slip out when loaded with trash. The preferred embodiment of the tensioning device element would be what is commonly called a spring, and provides tension to the pressure arms to hold them closed against the trash bag support frame. Alternative embodiments of the tensioning device might include, but is not limited to, a rubber, elastic, or bungee type strap, a hook, latch, or catch, or any other type device which would maintain the pressure arms closed tightly enough to secure the trash bag against the trash bag support frame. A lid connected by a pivoting swing connector device(s), commonly called a hinge(s), is positioned in a manner so it may be lifted up to open position to deposit trash and closed to seal off bag opening from intruding insects and minimize odors from wild animals.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top elevation view of a trash bag holder in accordance with the invention with the lip up in the open position at 90 degree angle to viewer and pressure arms closed;

FIG. 2 is a top elevation view of a trash bag holder in accordance with the invention shown in FIG. 1 with the lid up in the open position and the pressure arms open;

FIG. 3 is a top elevation view of a trash bag holder in accordance with the invention with the lid closed in the down position and pressure arms closed;

FIG. 4 is a side view of a trash bag holder in accordance with the invention;

FIG. 5 is a front view of a trash bag holder in accordance with the invention with the lid up in the open position and the pressure arms closed;

FIG. 6 is a front view of a trash bag holder in accordance with the invention with the lid down in the closed position and the pressure arms closed;

FIG. 7 is a front view of a trash bag holder in accordance with the invention with the lid down in the closed position and the pressure arms closed with a trash bag in place for use;

FIG. 8 is a front perspective view of a trash bag holder in accordance with the invention showing a trash bag attached by dotted line and whole assembly attached to a tree or post by dashed line; and

FIG. 9 is a top sectional view of the trash bag holder assembly strapped onto a tree.

For purposes of clarity and brevity, like elements and components will bear the same designations and numbering throughout the Figures.

### DESCRIPTION OF THE PREFERRED EMBODIMENT

The present invention provides a trash-bag holder. Within this context the present invention relates to plastic garbage or trash bags; but, the invention is also useful for other types of flexible bags.

Within the preferred embodiment, the invention uses a central body 7 which is adapted to be strapped to a tree trunk. The central body 7 is connected to a trash bag support frame 3 in the form of a rigid ring. The preferred embodiment of the invention uses metal; those of ordinary skill in the art readily recognize other materials which will serve in this capacity, such as but not limited to, high strength plastic, fiberglass, or composite material.

When the trash bag support frame 3 is attached to the central body 7, it creates a framework through which the plastic garbage/trash bag 9 is inserted. With the trash bag 9 is folded over the trash bag support frame 3, two opposing pressure arms 4 close together to encircle and hold the trash bag 9 between the trash bag support frame 3 and the pressure arms 4. Spring action tension is created to firmly secure the pressure arms 4 closed so as to prevent slippage during the loading of the bag with refuse. The tension of the pressure arms 4 is maintained by a tensioning device 5 such as but is not limited to, a spring connector. Once so installed, the mouth of the plastic bag is kept open; and when the central body 7 is strapped to a tree, the bag's mouth is properly positioned to serve as a portable garbage receptacle. To keep from attracting outdoor pests such as flying insects, a hinged lid cover 2 seals the opening to the mouth of the trash receptacle. The cover 2 is lifted up to deposit trash and closed once a deposit is made.

When the bag is full, it is easily removed from the trash bag support frame 3.

The invention, together with various embodiments thereof, will be more fully explained by the accompanying drawings and the following explanation.

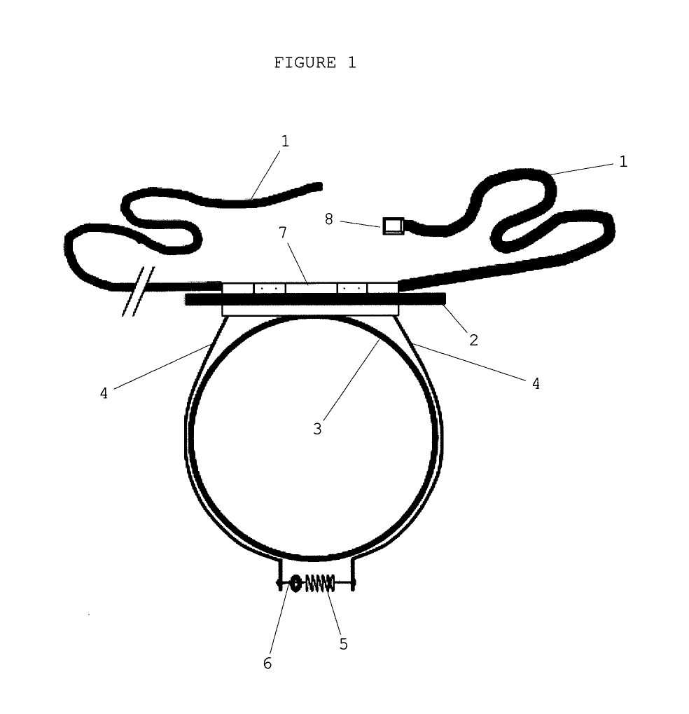

FIG. 1 is a top elevation view of the trash-bag holder in accordance with the invention with the cover 2 up in the open position at 90 degree angle to viewer and pressure arms 4 closed and the mounting strap 1 and mounting strap locking mechanism 8 being unattached to a tree/post/pole 13 on one end but attached to the body 7 on the other ends. The pressure arms 4 are slightly flexible and may be made of any material which will provide a firm hold of the trash-bag enclosed between the pressure arms 4 and trash bag support frame 3. The preferred embodiment utilizes pressure arms 4 made of any common metal such as, but not limited to aluminum. Any non-metal material which would provide the same function would be acceptable as well. The pressure arms 4 are held closed by a tensioning device 5 commonly called, but not limited to a spring which is hooked into an eyelet 6 to provide closure of the pressure arms 4. The mounting strap 1 may consist of any flexible material such as nylon, leather, plastic, fabric, canvas, cloth, rope, cord, or any composite material which will provide the ability to mount the invention to a tree/post/pole 13 by acting as a mounting strap 1. The mounting strap locking mechanism 8 may be provided in the form of such devices as a buckle, latch, snap, Velcro, catch, button, or any similar device which will allow the mounting strap 1 to be cinched tightly around a tree/post/pole 13 and locked firmly in place. For alternative embodiments, instead of using the mounting strap 1, the invention may be mounted to a pole, post, bench, table, rail, or wall using common fasteners such as bolts, screws, nails or similar type fastening devices which may or may not be used in combination with a mounting bracket.

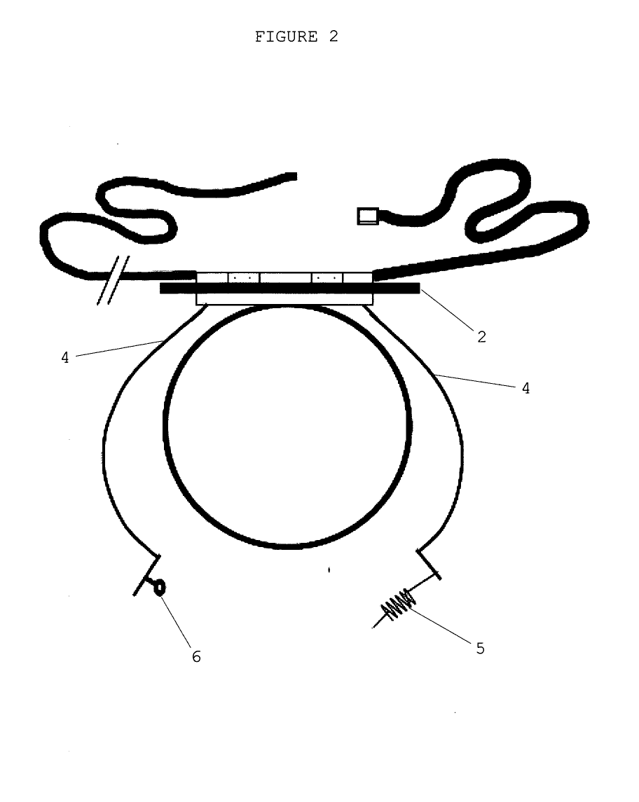

FIG. 2 is a top elevation view of the trash-bag holder in accordance with the invention shown in FIG. 1 with the cover 2 up in the open position and the pressure arms 4 open. The tensioning device 5, or spring in the preferred embodiment, is unhooked to the eyelet 6.

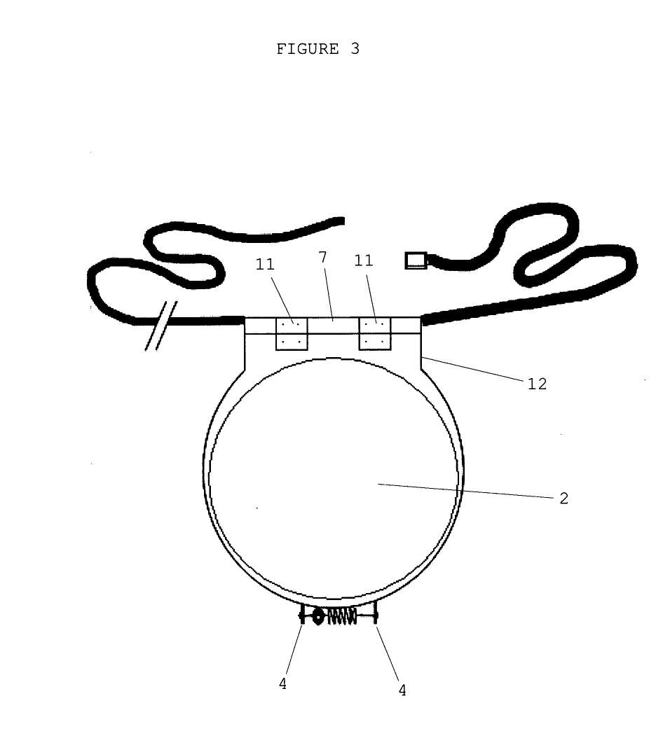

FIG. 3 is a top elevation view of the trash-bag holder in accordance with the invention in FIG. 1 with the cover 2 closed in the down position and pressure arms 4 closed. A hinge 11 or hinges attach to the cover mounting flange 12 and are swingably connected to the body 7.

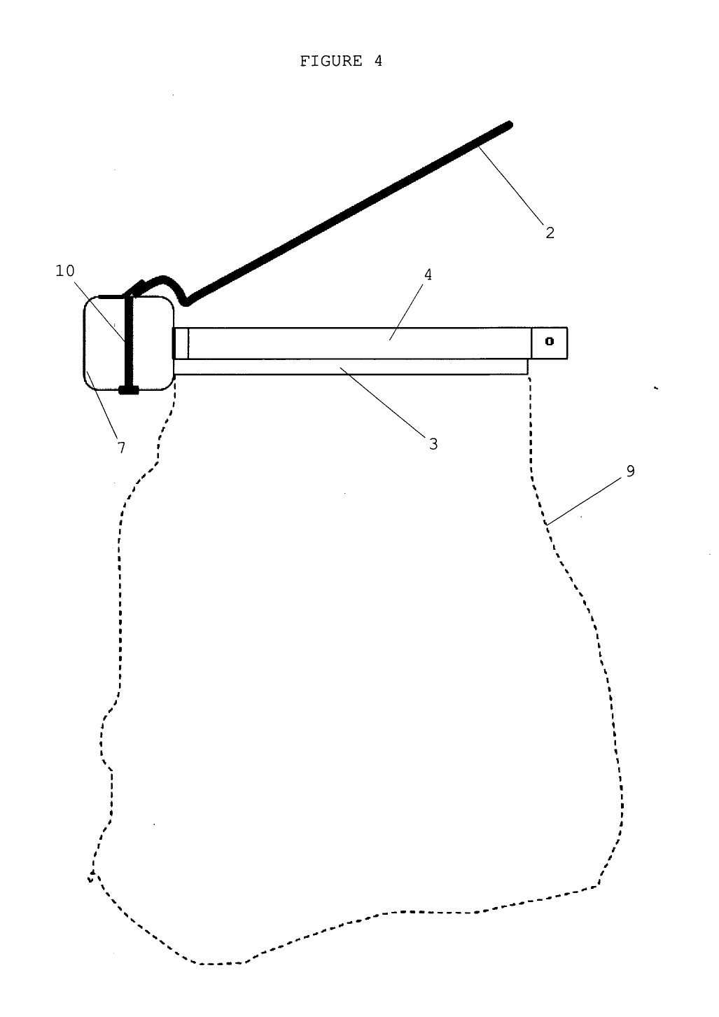

FIG. 4 is a side view of the trash-bag holder in accordance with the invention with the cover 2 up with the pressure arms 4 closed around the trash bag support frame 3. The mounting strap anchor 10 is visible being connected within the body 7 and a trash bag 9 inserted in the invention.

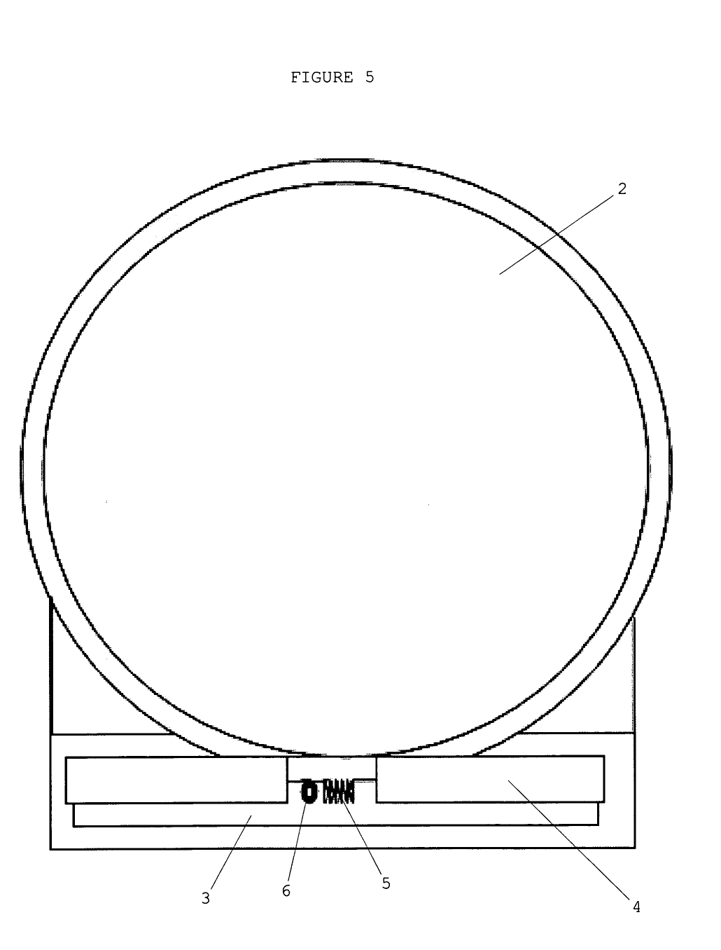

FIG. 5 is a front view of the trash-bag holder in accordance with the invention with the cover 2 up in the open position and the pressure arms 4 closed around the trash bag support frame 3 and tensioning device 5 connected to the eyelet 6.

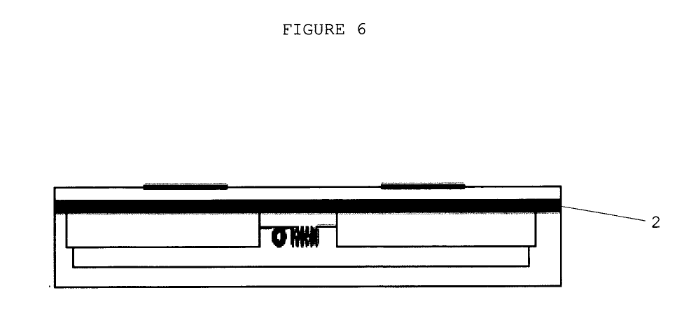

FIG. 6 is a front view of the trash-bag holder in accordance with the invention in FIG. 5 but with the cover 2 down in the closed position.

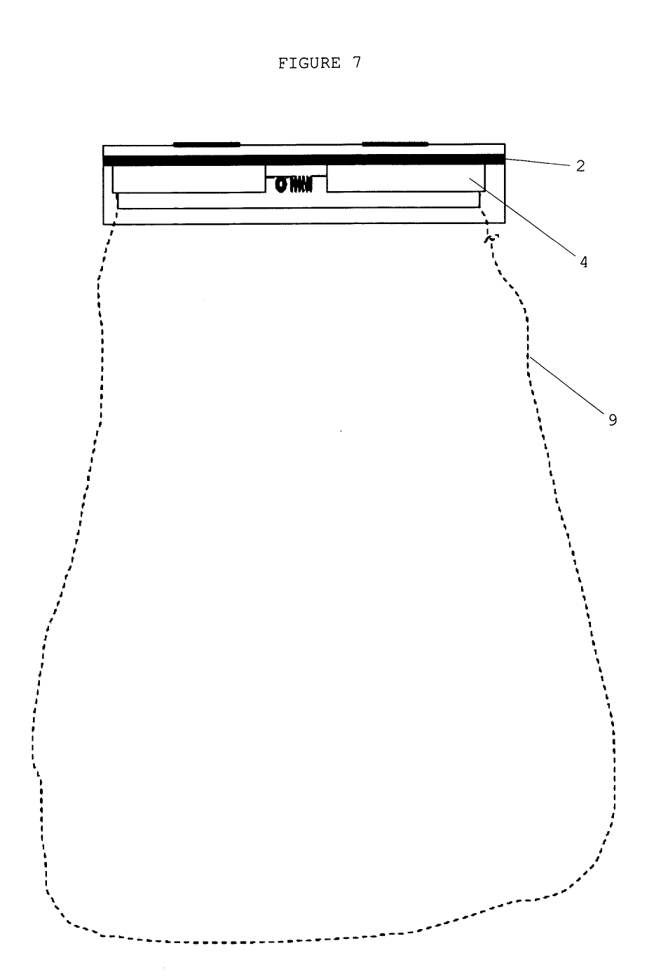

FIG. 7 is a front view of the trash-bag holder in accordance with the invention in FIG. 5 with the cover 2 down in the closed position and the pressure arms 4 closed but with a trash bag 9 in place for use.

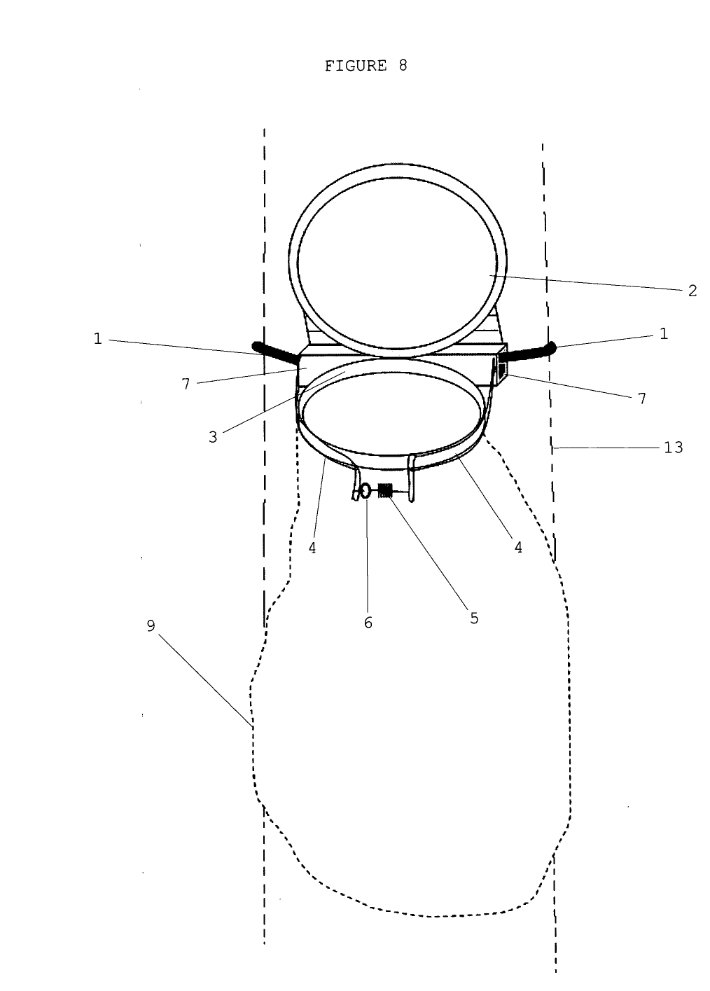

FIG. 8 is a front perspective view of trash-bag holder in accordance with the invention showing a trash bag 9 attached by dotted line and whole assembly attached to tree/post/pole 13 by dashed line. The pressure arms 4 are closed around the trash bag support frame 3, the tensioning device 5 in hooked into the eyelet 6 with the cover 2 is in the up position to receive trash. The mounting strap 1 anchors the body 7 around the tree/post/pole 13.

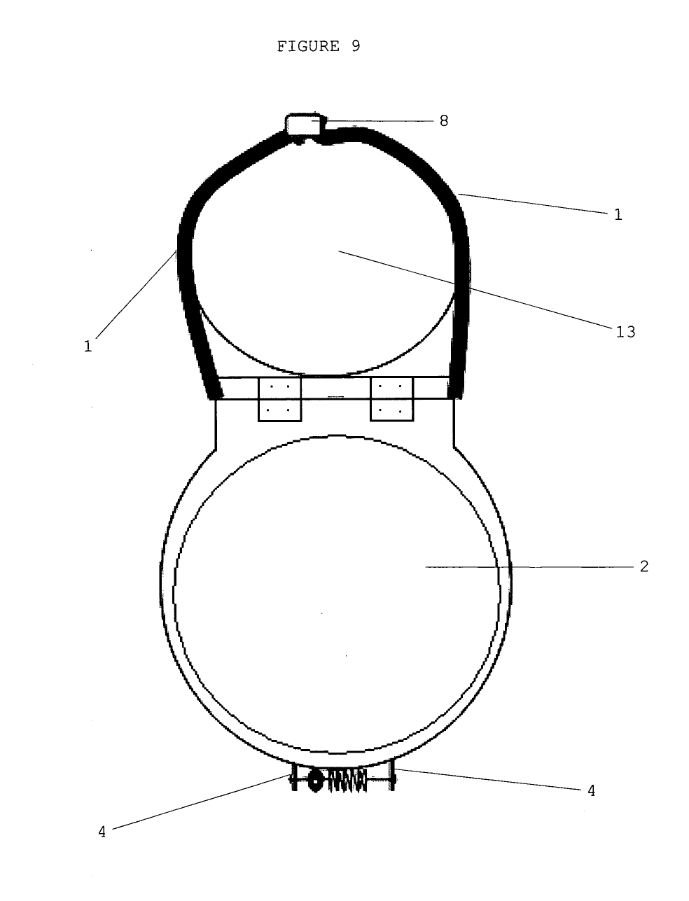

FIG. 9 is a top sectional view of the trash-bag holder assembly viewed looking downward with the pressure arms 4 closed, the cover 2 down in the closed position and the whole assembly secured to a tree/post/pole 13 by the mounting strap which cinches tight by the mounting strap locking mechanism 8.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A portable tree or pole/post mounted recreational trash bag holder with lid for holding a trash bag open for deposits and close off from insects when camping or picnicking outdoors, comprising:
means for securing invention to tree, pole, or post;
means for providing a lid to cover the opening of the trash receptacle;
means for providing a mounting frame for the trash bag to attach to;
means for holding the trash bag securely to the frame so it stays in place when filled;
means for providing tension to the pressure arms to keep arms closed tightly with trash bag between frame and pressure arms, securely connected to said means for holding the trash bag securely to the frame so it stays in place when filled;
means for providing a place for the hook of the tensioning device to secure to, rigidly connected to said means for holding the trash bag securely to the frame so it stays in place when filled;
means for providing a mounting area for the support frame and mounting strap to attach to, swingably connected to said means for holding the trash bag securely to the frame so it stays in place when filled, and rigidly connected to said means for providing a mounting frame for the trash bag to attach to;
means for providing a means to lock down the mounting strap tightly around a tree or pole, structurally connected to said means for providing a mounting area for the support frame and mounting strap to attach to, and correspondingly connected to said means for securing invention to tree, pole, or post;
means for an anchor for the mounting strap to attach to body, directly connected to said means for securing invention to tree, pole, or post;
means for providing a pivot to open the lid while remaining attached to body, hingeably fastened to said means for providing a mounting area for the support frame and mounting strap to attach to; and
means for connecting the cover to the hinges, securely connected to said means for providing a pivot to open the lid while remaining attached to body, and structurally connected to said means for providing a lid to cover the opening of the trash receptacle.

2. The portable tree or pole/post mounted recreational trash bag holder with lid in accordance with claim 1, wherein said means for securing invention to tree, pole, or post comprises a mounting strap.

3. The portable tree or pole/post mounted recreational trash bag holder with lid in accordance with claim 1, wherein said means for providing a lid to cover the opening of the trash receptacle comprises a cover.

4. The portable tree or pole/post mounted recreational trash bag holder with lid in accordance with claim 1, wherein said means for providing a mounting frame for the trash bag to attach to comprises a trash bag support frame.

5. The portable tree or pole/post mounted recreational trash bag holder with lid in accordance with claim 1, wherein said means for holding the trash bag securely to the frame so it stays in place when filled comprises a pressure arms.

6. The portable tree or pole/post mounted recreational trash bag holder with lid in accordance with claim 1, wherein said means for providing tension to the pressure arms to keep arms closed tightly with trash bag between frame and pressure arms comprises a tensioning device.

7. The portable tree or pole/post mounted recreational trash bag holder with lid in accordance with claim 1, wherein said means for providing a place for the hook of the tensioning device to secure to comprises an eyelet.

8. The portable tree or pole/post mounted recreational trash bag holder with lid in accordance with claim 1, wherein said means for providing a mounting area for the support frame and mounting strap to attach to comprises a body.

9. The portable tree or pole/post mounted recreational trash bag holder with lid in accordance with claim 1, wherein said means for providing a means to lock down the mounting strap tightly around a tree or pole comprises a mounting strap locking mechanism.

10. The portable tree or pole/post mounted recreational trash bag holder with lid in accordance with claim 1, wherein said means for an anchor for the mounting strap to attach to body comprises a mounting strap anchor.

11. The portable tree or pole/post mounted recreational trash bag holder with lid in accordance with claim 1, wherein said means for providing a pivot to open the lid while remaining attached to body comprises a hinge.

12. The portable tree or pole/post mounted recreational trash bag holder with lid in accordance with claim 1, wherein said means for connecting the cover to the hinges comprises a cover mounting flange.

13. A portable tree or pole/post mounted recreational trash bag holder with lid for holding a trash bag open for deposits and close off from insects when camping or picnicking outdoors, comprising:
a mounting strap, for securing invention to tree, pole, or post;
a cover, for providing a lid to cover the opening of the trash receptacle;
a trash bag support frame, for providing a mounting frame for the trash bag to attach to;
a pressure arms, for holding the trash bag securely to the frame so it stays in place when filled;
a tensioning device, for providing tension to the pressure arms to keep arms closed tightly with trash bag between frame and pressure arms, securely connected to said pressure arms;
an eyelet, for providing a place for the hook of the tensioning device to secure to, rigidly connected to said pressure arms;
a body, for providing a mounting area for the support frame and mounting strap to attach to, swingably connected to said pressure arms, and rigidly connected to said trash bag support frame;
a mounting strap locking mechanism, for providing a means to lock down the mounting strap tightly around a tree or pole, structurally connected to said body, and correspondingly connected to said mounting strap;
a mounting strap anchor, for an anchor for the mounting strap to attach to body, directly connected to said mounting strap;
a hinge, for providing a pivot to open the lid while remaining attached to body, hingeably fastened to said body; and
a cover mounting flange, for connecting the cover to the hinges, securely connected to said hinge, and structurally connected to said cover.

14. A portable tree or pole/post mounted recreational trash bag holder with lid for holding a trash bag open for deposits and close off from insects when camping or picnicking outdoors, comprising:
a mounting strap, for securing invention to tree, pole, or post;
a cover, for providing a lid to cover the opening of the trash receptacle;
a trash bag support frame, for providing a mounting frame for the trash bag to attach to;
a pressure arms, for holding the trash bag securely to the frame so it stays in place when filled;
a tensioning device, for providing tension to the pressure arms to keep arms closed tightly with trash bag between frame and pressure arms, securely connected to said pressure arms;
an eyelet, for providing a place for the hook of the tensioning device to secure to, rigidly connected to said pressure arms;
a body, for providing a mounting area for the support frame and mounting strap to attach to, swingably connected to said pressure arms, and rigidly connected to said trash bag support frame;
a mounting strap locking mechanism, for providing a means to lock down the mounting strap tightly around a tree or pole, structurally connected to said body, and correspondingly connected to said mounting strap;
a mounting strap anchor, for an anchor for the mounting strap to attach to body, directly connected to said mounting strap;
a hinge, for providing a pivot to open the lid while remaining attached to body, hingeably fastened to said body; and
a cover mounting flange, for connecting the cover to the hinges, securely connected to said hinge, and structurally connected to said cover.
